(19) United States
(12) Patent Application Publication
(10) Pub. No.: US 2013/0094047 A1
(43) Pub. Date: Apr. 18, 2013

(54) SYSTEMS AND METHODS FOR PRINTING DOCUMENTS USING A MOBILE DEVICE

(71) Applicant: GLOBAL GRAPHICS SOFTWARE LIMITED, Cambourne (GB)

(72) Inventors: Martin Paul Bailey, Cambridge (GB); Michael Finta, East Sussex (GB)

(73) Assignee: GLOBAL GRAPHICS SOFTWARE LIMITED, Cambourne (GB)

(21) Appl. No.: 13/650,512

(22) Filed: Oct. 12, 2012

Related U.S. Application Data
(60) Provisional application No. 61/547,545, filed on Oct. 14, 2011.

(51) Int. Cl. G06K 15/02

(52) U.S. Cl. 358/1.14; 358/1.15

(57) ABSTRACT

A method of printing a document using a mobile device includes establishing a first connection between a mobile device and a printer using NFC to identify the mobile device to the printer; establishing a second connection between the mobile device and the printer using WiFi; transferring a document from the mobile device to the printer over the second connection using the WiFi; and printing the document using the printer.

### CROSS-REFERENCE TO RELATED APPLICATIONS

This application claims the benefit under 35 U.S.C. §119(e) of U.S. Provisional Patent Application Ser. No. 61/547,545 filed on Oct. 14, 2011, which is incorporated herein by reference.

### FIELD

The invention relates to systems and method for printing documents using a mobile device. The invention also relates to systems and method for printing documents using a mobile device and using one communication protocol for establishing a connection and a different communication protocol for delivering the document to be printed. The invention also relates to systems and method for printing documents using a mobile device and using one communication protocol for delivering the document to be printed and a different communication protocol for payment or to release a stored document for printing.

### BACKGROUND

Printing from a mobile device is an expanding field. It is often desirable to have the capability to print from the mobile device at multiple locations and using different printers. A “mobile device” is defined herein to be any computing platform that is routinely carried by a user and can include, for example, cellular telephones, smart phones, and PDAs (personal digital assistants), especially (but not limited to) those capable of receiving emails or accessing the internet; digital still picture cameras; personal media players, especially those capable of storing and displaying still images and documents; laptop, notebook, netbook, and tablet computers; and ‘slate’ computers, such as the Apple iPAD™.

A variety of transport hardware and protocols are available for transmitting data from a mobile device. These include a) Bluetooth™ (using short wavelength radio transmissions), b) Near Field Communication (NFC) protocols (e.g., wireless transfer at 13.56 MHz), c) WiFi (Wireless Fidelity—e.g., using variations of the IEEE 802.11 standard), and d) physical connection (for example, using the USB standard).

Wireless connections have a tendency to fall along a spectrum. One end of the spectrum is typified by NFC protocols that have a number of characteristics. For example, NFC connections are typically highly secure. NFC is expected to be widely used for micropayment solutions and systems that often include a hardware security element. NFC connections are typically very easy for occasional users to make a connection. For example, billing and access control systems based around NFC are expected to be already available in public and organization infrastructure; once the system is in place making a secure connection is very simple. NFC connections are generally very short range. A typical maximum range is on the order of 4-10 cm. NFC connections typically have comparatively low data transfer rates (for example, 424 kbit/s).

On the other end of the spectrum is WiFi. WiFi connections are typically securable, but at the expense of making connecting rather difficult for occasional users.

Various security models are in place, including WEP, WPA and WPA2, the first two of which are known to be vulnerable to cracking Each security model typically requires that a user manually enters a password which must have been previously obtained from an appropriate source. Thus WiFi can be convenient for regular users, but requires pre-planning and may be slow or difficult to set up for people who do not use a specific connection repeatedly. WiFi connections typically have longer range, for example, a range on the order of tens of meters indoors. WiFi connections typically have comparatively high data transfer rates (for example, up to 300 MBit/s for dual-channel 802.11n and up to 54 MBit/s for 802.11g).

Bluetooth typically falls somewhat in the middle on all criteria except security, where it's arguably less secure than WiFi, but the security capabilities vary by Bluetooth version.

### BRIEF SUMMARY

One embodiment is a method of printing a document using a mobile device. The method includes establishing a first connection between a mobile device and a printer using NFC (Near Field Communication) to identify the mobile device to the printer; establishing a second connection between the mobile device and the printer using WiFi (Wireless Fidelity); transferring a document from the mobile device to the printer over the second connection using WiFi; and printing the document using the printer. Typically, NFC is more secure than WiFi, WiFi has a higher data rate than NFC, and WiFi has a longer range than NFC. In some embodiments, the first connection is established before the second connection. In other embodiments, the second connection is established before the first connection.

Another embodiment is a computer readable storage medium having processor-executable instructions. The processor-executable instructions when installed onto a system enable the system to perform actions. The actions include establishing a first connection between a mobile device and a printer using NFC to identify the mobile device to the printer; establishing a second connection between the mobile device and the printer using WiFi; and transferring a document from the mobile device to the printer over the second connection using WiFi.

Yet another embodiment is a system for printing a document that includes a mobile device and a printer. The system also includes at least one processor (for example, in the mobile device, the printer, or both) that is configured and arranged to establish a first connection between the mobile device and the printer using NFC to identify the mobile device to the printer; establish a second connection between the mobile device and the printer using WiFi; and transfer a document from the mobile device to the printer over the second connection using WiFi.

A further embodiment is a mobile device that includes a memory unit and at least one processor coupled to the memory unit and configured and arranged to establish a first connection between the mobile device and a printer using NFC to identify the mobile device to the printer; establish a second connection between the mobile device and the printer using WiFi; and transfer a document from the mobile device to the printer over the second connection using WiFi.

Another embodiment is a printer that includes a print engine and at least one processor coupled to the print engine and configured and arranged to establish a first connection between a mobile device and the printer using NFC to identify the mobile device to the printer; establish a second connection between the mobile device and the printer using WiFi; receive a document from the mobile device over the second connection using WiFi; and print the document using the print engine.

Another embodiment is a method of printing a document using a mobile device. The method includes establishing a first connection between a mobile device and a printer using a network protocol (such as a WiFi protocol); delivering the document to be printed to the printer over the first connection; establishing a second connection between the mobile device and the printer using NFC after the document to be printed has been sent from the mobile device; identifying the mobile device (or the user of the mobile device) using the second connection; releasing the document previously delivered to be printed; and printing the document using the printer.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1 is a schematic representation of one embodiment of an environment in which the invention can be employed;

FIG. 2 is a schematic flow chart of one embodiment of printing a document using a mobile device and a printer, according to the invention, where the mobile device is approved before delivery of the document to the printer; and

FIG. 3 is a schematic flow chart of one embodiment of printing a document using a mobile device and a printer, according to the invention, where the document is delivered to the printer before approval of the mobile device.

### DETAILED DESCRIPTION

The invention relates to systems and method for printing documents using a mobile device. The invention also relates to systems and method for printing documents using a mobile device and using one communication protocol for establishing a connection and a different communication protocol for delivering the document to be printed.

The methods, systems, and devices described herein may be embodied in many different forms and should not be construed as limited to the embodiments set forth herein. Accordingly, the methods, systems, and devices described herein may take the form of an entirely hardware embodiment, an entirely software embodiment or an embodiment combining software and hardware aspects. The following detailed description is, therefore, not to be taken in a limiting sense. The methods described herein can be performed using any type of printer that includes a processor. Suitable printers and mobile devices typically include mass memory and typically include methods for communication with other devices including mobile devices. The mass memory illustrates a type of computer-readable media, namely computer storage media. Computer storage media may include volatile, nonvolatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a printer.

Methods of communication can include both wired and wireless (e.g., RF, optical, or infrared) communications methods and such methods provide another type of computer readable media; namely communication media. Communication media typically embodies computer-readable instructions, data structures, program modules, or other data in a modulated data signal such as a carrier wave, data signal, or other transport mechanism and includes any information delivery media. The terms “modulated data signal,” and “carrier-wave signal” includes a signal that has one or more of its characteristics set or changed in such a manner as to encode information, instructions, data, and the like, in the signal. By way of example, communication media includes wired media such as twisted pair, coaxial cable, fiber optics, wave guides, and other wired media and wireless media such as acoustic, RF, infrared, and other wireless media.

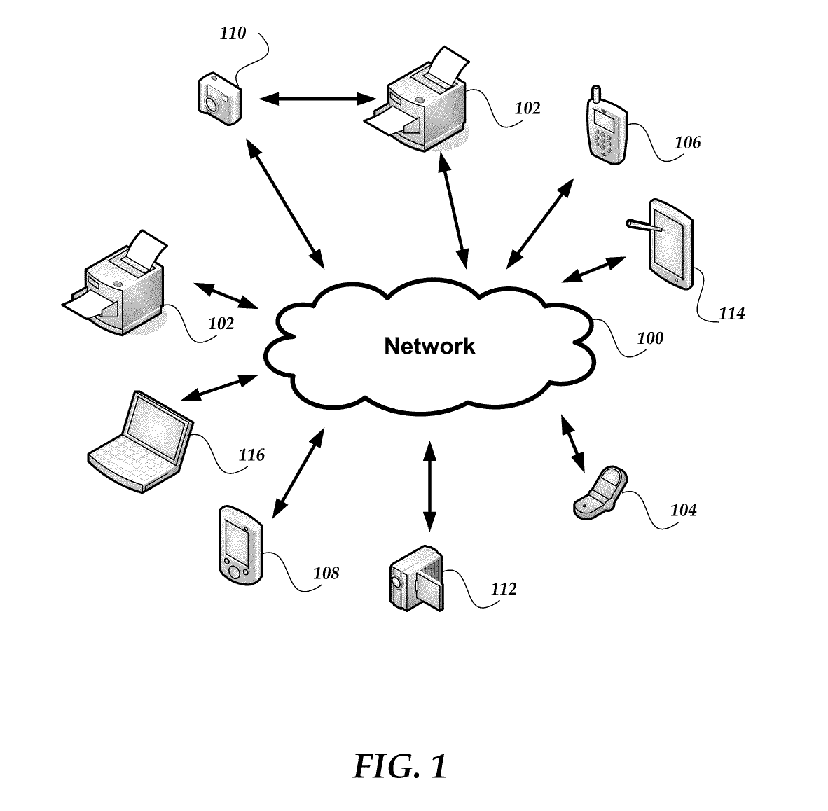

FIG. 1 illustrates one embodiment of an environment for the invention. In FIG. 1, a network environment is illustrated, but it will be understood that the invention is also applicable to unnetworked devices (e.g., printers and mobile devices) as well. It will be understood that the network environment can be a local area network, a wide area network, or any combination thereof. It will also be understood that the network can include devices, other than those illustrated, coupled to the network and that there may be multiple devices of each type illustrated connected to the network.

The illustrated environment of FIG. 1 includes a network 100 to which is attached, either directly or through other devices, one or more printers 102 and one or more mobile devices which may include, for example, cell phones 104, smart phones 106, personal data assistants (PDA's) 108, cameras 110, video cameras 112, tablet or slate computers 114, and laptop computers 116. Other devices can optionally be attached to the network such as computers, servers, portable storage devices (e.g., compact discs, DVDs, memory sticks, flash drives, or other optical or magnetic storage media), and the like. Any of these devices can be connected directly to the network or via another device. A mobile device (e.g., camera 110) can optionally be connected directly to a printer 102 through a wired or wireless connection or can be connected to the printer through the network. Attachment to the network or to devices in the network can be wired or wireless connection or any combination thereof.

The printer and the mobile device typically include a processor that can process the document and a memory unit for storage of the documents or portions of the document. The printer also includes a print engine for printing the document. Any suitable printer can be used including, but not limited to, inkjet and laser printers. The mobile device also includes a transmission unit for transmitting and receiving data. The printer may also include a transmission unit or is coupled to a device, such as a computer or server or a WiFi access point, that has a transmission unit for transmitting and receiving data.

A general mobile print solution ideally has one or more (and preferably all) of the following characteristics: a) capable of being highly secure (for example, to enable access control, accounting and billing, although some installations may choose not to use the security); b) easy for occasional users to make a connection; c) have a long enough range to enable a user to submit files easily without risk of disconnection (an acceptable range may vary, for example, with the time that a typical job will take to transfer; a longer time argues for a longer range to reduce the risk of disconnection); and d) have a high enough data rate to transfer documents to the printer in a reasonable time (document size varies greatly with the class of document; a representative sample of Word, PowerPoint and PDF files averaged approximately 400 kB/page; thus a typical 4 page document would be 1.6 MB, and would likely take something on the order of 1 second on WiFi (802.11g), or 2 minutes over NFC).

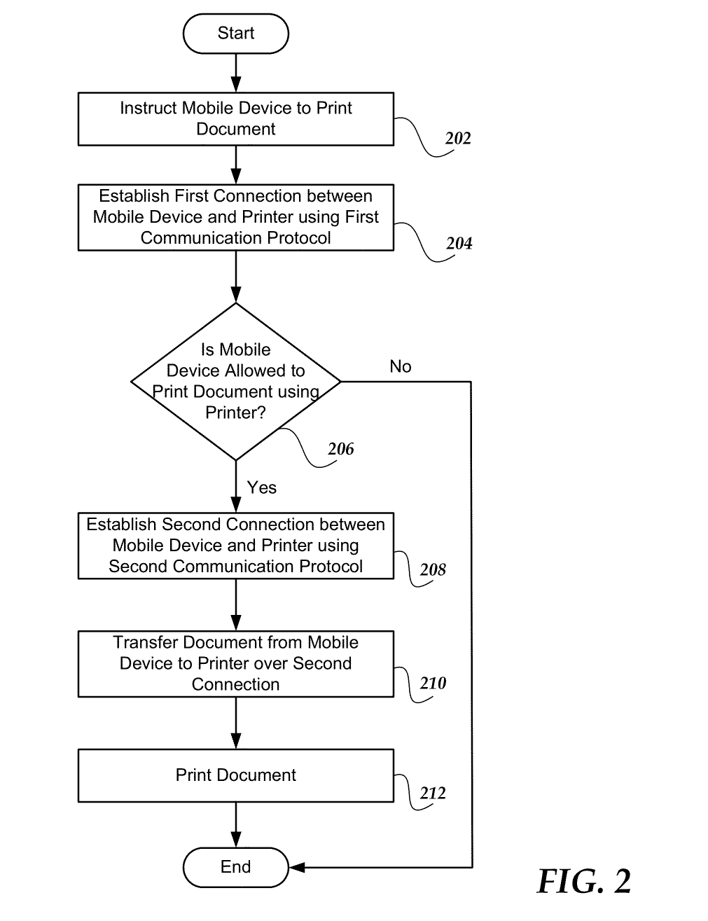

A combination of multiple transport hardware/protocols can be used to avoid the short-comings of each individually. FIG. 2 illustrates one embodiment of a method of printing a document. In this embodiment, a user instructs a mobile device to print a document (step 202). The mobile device makes a first connection with a printer using near field communication (NFC), such as a NFC protocol based on the ISO 18092, ISO 14443, ISO 21481, or FeliCa standards (step 204). The first connection is used to identify the mobile device to the printer.

NFC has relatively high security and relatively low range, which meets the needs for establishment of the identity of the mobile device. In some embodiments, NFC includes transmission at 13.56 MHz. In some embodiments, NFC includes transmission at a data rate up to 424 kbit/s.

The discovery of an available printer and association with the printer using NFC may be performed in any of a variety of ways, including those described in the NFC standards identified above. In some embodiments, the first connection established using NFC is optionally used to deliver to the mobile device data related to transaction types that the printer supports, data related to the capabilities of the printer (e.g. color versus monochrome, whether it supports duplex etc), or any combination thereof. In some embodiments, the identification of the user is supported by authentication provided by a secure element within the mobile device.

In some embodiments, the printer queries an access control system over a wired or wireless network, to obtain details of functions that the user or mobile device is allowed to use on that device, the times of day at which they are allowed to print, the maximum number of pages per day (or other period) that they may print, and the like. Alternatively, the printer may optionally have been pre-programmed with access control data.

If the user or mobile device is allowed to print a document on the printer (step 206), then a second connection is established between the mobile device and the printer using WiFi (step 208). If the user or mobile device is not allowed to print the document on the printer then the process is terminated (as illustrated in FIG. 2) or optionally the mobile device can attempt to connect with another printer for printing the document. The second connection is a wireless connection using WiFi using a protocol based on an IEEE 802.11 standard (e.g., a 802.11, 802.11a, 802.11b, 802.11g, or 802.11n standard). In some embodiments, WiFi includes transmission at 2.4 GHz, 3.7 GHz, or 5 GHz.

WiFi and the second connection are typically less secure, have a higher data rate, and have a longer range, than NFC and the first connection. In some embodiments, WiFi includes transmission at a maximum data rate of at least 1 Mbit/s, at least 6 Mbit/s, at least 7.2 Mbit/s, or at least 14 Mbit/s. In some embodiments, WiFi includes transmission at a maximum data rate in the range of 6 to 54 Mbit/s or in the range of 15 to 300 Mbit/s.

In at least some embodiments, the second connection is secured. In one embodiment, the printer provides a unique ID over the first connection which must be transmitted back by the mobile device over the second connection or used as a key to encrypt the document (or other data) sent over the second connection. In another embodiment, the mobile device provides a unique ID over the first connection which must be transmitted back by the mobile device over the second connection or used as a key to encrypt the document (or other data) sent over the second connection. In one embodiment, the printer provides a password (for example, a WEP, WPA or WPA2 password) to the mobile device over first connection, which is then used to establish the second connection.

Once the second connection is established, the document is transferred over the second connection using WiFi (step 210). The printer proceeds to print the document (step 212). The printer may wait until the entire document is received or the printer may begin printing the document before the entire document has been received. In some embodiments, it may be possible to transfer multiple documents over the second connection. In other embodiments, a new second connection is established for each document.

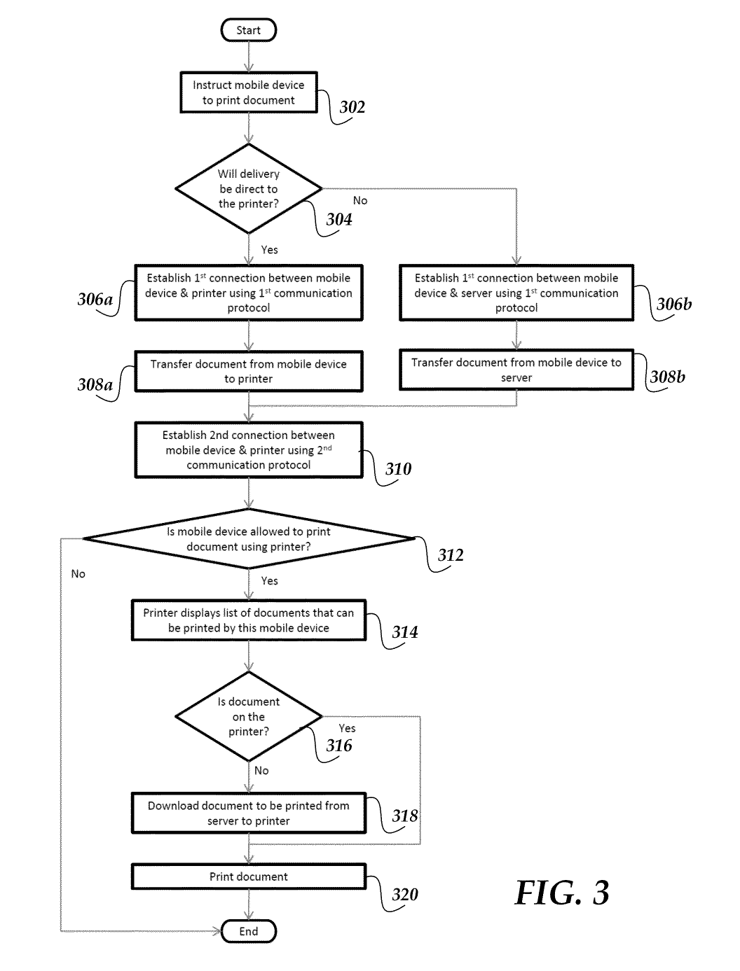

An alternative implementation reverses the order of the identification of the mobile device using NFC and the delivery of the document to be printed using WiFi. FIG. 3 is a flow chart illustrating embodiments of this approach. In these embodiments the document to be printed is delivered either to the printer or to a storage area (e.g., a server) that is accessible to the printer using a first established connection (e.g., a connection using a WiFi protocol). The delivery of the document may use any appropriate protocol and connection method including, but not limited to, storing as a file on a file system remote from the mobile device; and transmission as an email attachment. Once the document has been delivered the user may then establish a second connection between the mobile device and the printer using, for example, NFC. The mobile device is identified over the second connection; the printer establishes the credentials of that device for printing; the user releases one or more documents stored on the printer, or accessible to the printer (e.g., stored in the storage area which is accessible to the printer), for printing; and the documents are printed using the printer.

Turning specifically to FIG. 3, the mobile device is instructed to print a document (step 302). Optionally, the mobile device is instructed (step 304) whether to deliver the document directly to the printer or to a server. Alternatively, the option to choose between printer or server may not be present in an embodiment.

A first connection is established between the mobile device and the printer (step 306a) or server (step 306b) using a first communication protocol (e.g., a WiFi protocol).

The document is then transferred to the printer (step 308a) or server (step 308b). A second connection is established between the mobile device and the printer using a second communication protocol (e.g., a NFC protocol) to identify the mobile device to the printer (step 310) and establish whether the printer is allowed to print the document (step 312). Optionally, the printer displays a list of documents that can be printed by the identified mobile device (step 314). Optionally, it is determined whether the document is already provided to the printer (step 316) and, if not, the document is downloaded from the server (step 318). The document is then printed by the printer (step 320).

In at least some embodiments, the mobile device sends print configuration data to the printer. This may include one or more items such as the number of copies to print, whether they should be printed simplex or duplex, the paper tray to take paper from in the printer, the page range within a document that should be printed, and the like. This data may be transmitted over the first connection, the second connection, or a combination thereof.

In some embodiments, the printer may send a communication to the mobile device indicating that the document has been printed. In some embodiments, the printer transmits details of the document printed (e.g. the number and size of pages, whether it was printed in color or monochrome), the identity of the user, or a combination thereof to a charging system to handle payment for the print service. In some embodiments, this information is transmitted to a logging or other system within an organization that tracks usage of printers

It will be understood that the mobile device may communicate directly with the printer or through an intermediary (e.g., server, computer, or the like) that is coupled (e.g., through one or more wired or wireless connections) to the printer. The first and second connections may be established between the mobile device and the intermediary; thus, indirectly coupling the mobile device to the printer. For example, these methods can be used to connect indirectly from mobile device to printer, e.g. mediated through an on-premise cloud server, or through an abstraction representing one or more printers within an organization's printing service.

The document to be printed may be sent in a commonly used page description language (PDL), such as the PostScript Language defined by Adobe Systems or the Printer Control Language (PCL) defined by Hewlett-Packard; alternatively it may be provided in a static page representation such as the Portable Document Format (PDF) defined by Adobe Systems, or the XML Paper Specification (XPS), defined by Microsoft; in some embodiments it may also be provided in a native office document format, such as a Microsoft Word, Microsoft PowerPoint or OpenOffice document. The mobile device may optionally choose to convert the document into a supported format before transmitting it based on printer capabilities received from the printer.

The above specification, examples and data provide a description of the manufacture and use of the composition of the invention. Since many embodiments of the invention can be made without departing from the spirit and scope of the invention, the invention also resides in the claims hereinafter appended.

What is claimed as new and desired to be protected by Letters Patent of the United States is:

1. A method of printing a document using a mobile device, the method comprising:
establishing a first connection between a mobile device and a printer using NFC to identify the mobile device to the printer;
establishing a second connection between the mobile device and the printer using WiFi;
transferring a document from the mobile device to the printer over the second connection using WiFi; and
printing the document using the printer.

2. The method of claim 1, wherein the first connection is established before the second connection.

3. The method of claim 1, wherein the second connection is established before the first connection.

4. The method of claim 3, wherein the first connection is established after the document is transferred from the mobile device to the printer.

5. The method of claim 3, further comprising identifying the mobile device over the first connection, wherein transferring a document comprises releasing the document for transfer from the mobile device to the printer after identifying the mobile device to the printer.

6. The method of claim 1, further comprising transmitting a unique ID over the first connection, wherein establishing the second connection comprises presenting the unique ID over the second connection.

7. The method of claim 1, further comprising transmitting a password over the first connection, wherein establishing the second connection comprises presenting the password in order to establish the second connection.

8. The method of claim 1, further comprising transmitting an encryption key over the first connection, wherein transferring the document comprises encrypting the document using the encryption key, transferring the encrypted document from the mobile device to the printer over the second connection, and decrypting the encrypted document after transfer.

9. The method of claim 1, further comprising transmitting data regarding capabilities of the printer to the mobile device over the first connection.

10. The method of claim 1, further comprising indicating to the mobile device that the printer is available for printing prior to establishing the first connection.

11. A computer readable storage medium having processor-executable instructions, the processor-executable instructions when installed onto a system enable the system to perform actions, comprising:
establishing a first connection between a mobile device and a printer using NFC to identify the mobile device to the printer;
establishing a second connection between the mobile device and the printer using WiFi; and
transferring a document from the mobile device to the printer over the second connection using WiFi.

12. A system for printing a document, the system comprising:
a mobile device; and
a printer;
wherein the system comprises at least one processor and the at least one processor is configured and arranged to
establish a first connection between the mobile device and the printer using NFC to identify the mobile device to the printer;
establish a second connection between the mobile device and the printer using WiFi; and
transfer a document from the mobile device to the printer over the second connection using WiFi.

13. The system of claim 12, further comprising an intermediary device coupled to the printer and configured and arranged for establishment of the first and second connections between the mobile device and the printer via the intermediary device.

14. The system of claim 13, wherein the intermediary device is a computer or server.

15. The system of claim 12, further comprising a network, wherein the mobile device and the printer are coupled to the network and the first and second connections are formed through the network.

16. A mobile device, comprising:
a memory unit; and
at least one processor coupled to the memory unit and configured and arranged to establish a first connection between the mobile device and a printer using NFC to identify the mobile device to the printer;
establish a second connection between the mobile device and the printer using WiFi; and
transfer a document from the mobile device to the printer over the second connection using WiFi.

17. The mobile device of claim 16, wherein the mobile device is a cell phone, smart phone, personal data assistant, camera, or video camera.

18. A printer, comprising:
a print engine; and
at least one processor coupled to the print engine and configured and arranged to establish a first connection between a mobile device and the printer using NFC to identify the mobile device to the printer;
establish a second connection between the mobile device and the printer using WiFi;
receive a document from the mobile device over the second connection using WiFi; and
print the document using the print engine.

19. The printer of claim 18, wherein the printer is an inkjet printer or a laser printer.

20. The printer of claim 18, wherein the processor is configured and arranged to transmit an encryption key, unique ID, or password to the mobile device over the first connection.
